(19) United States
(12) Patent Application Publication
(10) Pub. No.: US 2008/0060619 A1
(43) Pub. Date: Mar. 13, 2008

(54) Fuel vapor generator for enhanced cold starting of an internal combustion engine

(76) Inventors: Brian K. Allston, Rochester, NY (US); Kenneth J. Dauer, Lima, NY (US); Murri H. Decker, Phelps, NY (US); Daniel F. Kabasin, Rochester, NY (US); Jongmin Lee, Pittsford, NY (US); David J. Trapasso, Bloomfield, NY (US); Luciano Felice, Sta Barbara (BR); Rui B. Campos, Limeira (BR)

Correspondence Address: DELPHI TECHNOLOGIES, INC., M/C 480-410-202, PO BOX 5052, TROY, MI, 48007, US

(21) Appl. No.: 11/581,836

(22) Filed: Oct. 17, 2006

Related U.S. Application Data
(60) Provisional application No. 60/844,292, filed on Sep. 13, 2006.

(51) Int. Cl. F02G 5/00

(52) U.S. Cl. 123/549

(57) ABSTRACT

A fuel vapor generator disposed in the intake manifold of an internal combustion engine. The vapor generator enriches air passing through the manifold to the individual cylinders to enhance engine starting capability, especially at low ambient temperatures. A dedicated fuel injector dispenses atomized fuel onto the surface of an electrically-heated element spaced apart from the nozzle of the fuel injector. The element is positioned within the manifold such that evaporated fuel is immediately swept from the generator by intake air and mixed with air in the manifold. In one aspect of the invention, the location for the heating element is immediately downstream of the manifold air intake throttle valve. The invention is especially useful for spark-ignited engines.

### RELATIONSHIP TO OTHER APPLICATIONS AND PATENTS

This application claims priority from U.S. Provisional Patent Application Ser. No. 60/844,292, filed Sep. 13, 2006.

### TECHNICAL FIELD

The present invention relates to internal combustion engines; more particularly, to means for starting internal combustion engines fueled by low-volatility fuels; and most particularly, to the generation of fuel vapor in an engine intake manifold to enhance the cold-starting capabilities of engines fueled by alcohols and alcohol/gasoline mixtures.

### BACKGROUND OF THE INVENTION

For starting, internal combustion engines rely on having a compressed fuel/air mixture that is combustible in a combustion cylinder. For spark-ignited gasoline-fueled engines, such a condition generally presents little problem except at extremely low temperatures. However, for engines fueled by fuels much less volatile than gasoline, for example, alcohols such as ethanol, or mixtures of ethanol and gasoline, starting can be difficult or impossible under temperature conditions experienced seasonally in many parts of the world. The problem is further exacerbated by the presence of water in such mixtures, as ethanol cannot be produced inexpensively as the pure compound but rather distills as a 95/5% ethanol/water azeotrope.

In Brazil, for example, where many modern vehicles are fueled by pure azeotrope, it is highly desirable to provide some means for enhancing the cold starting capabilities of such vehicles.

Most spark-ignited vehicles currently being produced for consumer use, as opposed to racing or other specialty vehicles, utilize fuel injectors for dispensing fuel into either the runners of an intake manifold (“port injection”) or the cylinders themselves (“direct injection”). It is known to provide means for warming liquid fuel just before the point of injection, to assist in vaporization of the subsequently-injected fuel. See U.S. Pat. No. 5,690,080 which discloses within a fuel injector a fuel chamber containing a disk-shaped element formed of an electrically-resistive material having a positive temperature coefficient (PTC) of resistance which draws electric current to heat cold fuel passing by, but gradually shuts down as the fuel temperature is increased. Such an approach can be useful in enhancing starting of direct-injected engines, either spark-ignited or compression-ignited. A drawback is the requirement that all of the fuel injectors in the engine must be so equipped. Another drawback is that volatilization of the fuel is not caused directly and must be assumed to proceed spontaneously as a function of the total heat budget of the engine, air, and warmed fuel.

What is needed in the art is a means for enhancing the cold-starting capability of a port-injected, direct injected, or carbureted internal combustion engine, and especially a spark-ignited engine, when fueled by a fuel having relatively low volatility.

It is a principal object of the present invention to increase the ease and reliability of starting such an engine at relatively low ambient fuel and air temperatures.

### SUMMARY OF THE INVENTION

Briefly described, a fuel vapor generator is disposed in the intake manifold of a spark-ignited internal combustion engine, which may be port-injected, direct-injected, or carbureted. The object of the fuel vapor generator is to enrich with vaporized fuel the air passing through the manifold to the individual cylinders such that, upon compression within the cylinders, an explosive air/fuel mixture is created that can be discharged by a sparking plug. The fuel vapor generator may be sized such that its output is relatively low and suffices to augment the fuel being supplied ordinarily to the individual cylinders via their dedicated port or direct fuel injectors. Alternatively, the fuel vapor generator may be sized such that its output is sufficient to create a combustible mixture within the intake manifold sufficient to start and run the engine without port or direct fuel injection for some period of time.

In either embodiment, a fuel vapor generator in accordance with the invention comprises a dedicated fuel injector for dispensing atomized fuel onto a heater spaced apart from the nozzle of the fuel injector. The heater may be electrically energized, being formed, for example, of any convenient conductive material exhibiting significant electrical resistance. In one aspect of the invention, the heating element is formed of PTC resistance material to be essentially self-regulating according to thermal conditions in the manifold and/or evaporative load on the element. In alternative configurations, the electrically-driven fuel-heating element may be defined as a plate; as one or a plurality of glow plugs; or as a sinuous element formed from a metal plate. Preferably, the element is positioned within the manifold such that evaporated fuel is immediately swept from the generator and mixed with air in the manifold; in one aspect of the invention, such a location may be immediately downstream of the manifold air intake throttle valve.

Combinations of these two embodiments are also possible, and an engine control module can readily monitor the fuel load being supplied to the engine at all times and can controllably vary the output of both the vapor generator injector and the individual port or direct injectors in a smooth, fuel-efficient, start-up/warm-up protocol.

A fuel vapor generator in accordance with the invention is readily adaptable for use with a spark-ignited engine. A vapor generator may also find use in a compression-ignited engine such as a diesel engine, although control in such an application should be expected to be quite demanding, to prevent pre-ignition of the compressed charge. Advantageously, a portion of the required fuel may be provided by the fuel vapor generator at a level too low to cause early compressive firing but high enough to enhance eventual combustion, with the balance of fuel being direct injected as in the prior art to cause combustion at the desired timing. Such use, although anticipated by the present invention, is not considered further within the following description, which is directed exclusively to spark-ignited engines.

### BRIEF DESCRIPTION OF THE DRAWINGS

The present invention will now be described, by way of example, with reference to the accompanying drawing, in which:

FIG. 1a is a side elevational view of a first embodiment of a vapor generator in accordance with the invention;

FIG. 1b is an isometric view of the first embodiment shown in FIG. 1a;

FIG. 2 is a schematic view of a manifold arrangement for a spark-ignited internal combustion engine, showing a placement for a fuel vapor generator in accordance with the invention;

FIG. 3a is a cross-sectional view of a second embodiment of a fuel vapor generator in accordance with the invention;

FIG. 3b is an isometric view of the second embodiment shown in FIG. 3a;

FIG. 4 is a plan view of a third embodiment of a fuel vapor generator in accordance with the invention;

FIG. 5 is a plan view of a fourth embodiment of a vapor generator in accordance with the invention; and

FIG. 6 is an isometric view of the fourth embodiment shown in FIG. 5.

The exemplifications set out herein illustrate various possible embodiments of the invention, including one preferred embodiment in one form, and such exemplifications are not to be construed as limiting the scope of the invention in any manner.

### DESCRIPTION OF THE PREFERRED EMBODIMENTS

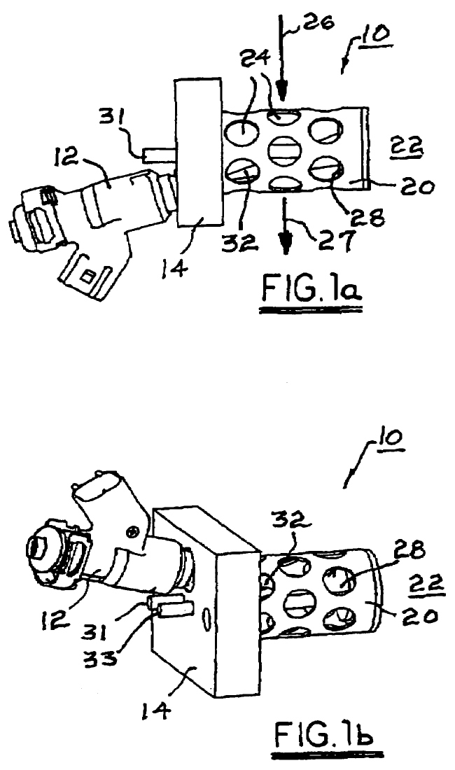

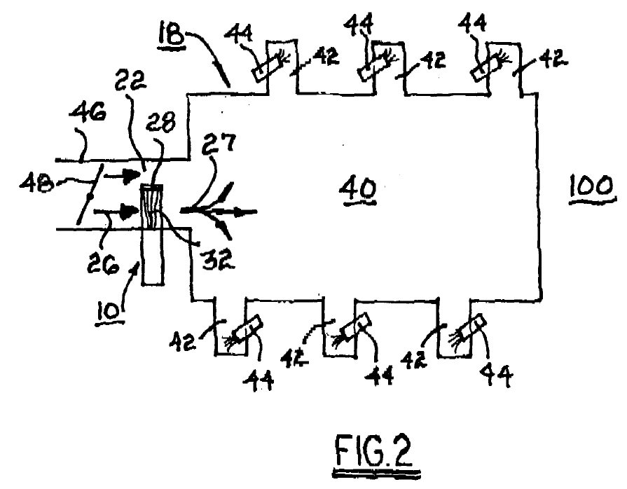

Referring to FIGS. 1a and 1b, a first embodiment 10 of a fuel vapor generator in accordance with the invention comprises an atomizing fuel injector assembly 12, similar in construction and operation to prior art fuel injectors as are well known in the art for providing pulsed injection of fuel. Fuel injector assembly 12 is sealingly mated to a generator body 14 for mounting to the wall of an intake manifold 18 (FIG. 2). Fuel injector assembly 12 extends through body 14 and the manifold wall into an interior air flow space 22 of intake manifold 18.

An electrically heated vaporization element 28 is off-spaced from fuel injector 12 by standoff 20. Standoff 20 is perforated with a plurality of openings 24 to allow air 26 flowing through manifold 18 to pass through standoff 20. Atomized fuel spray 32 is directed from fuel injector assembly 12 onto vaporization element 28. Element 28 is connected to electrical leads 31,33 for control by a electrical circuit (not shown). In one aspect of the invention, element 28 is formed from a material having a positive thermal coefficient of resistance, as is known in the prior art and disclosed in, for example, U.S. Pat. No. 5,690,080, the relevant disclosure of which is incorporated herein by reference. Alternatively, heating element 28 may take the form of a simple resistance wire heater, as is well known in the art.

In operation, a signal from a controller (not shown) causes fuel injector assembly 12 to inject a fuel spray 32 into standoff 20, which fuel spray strikes the surface of vaporization element 28 within standoff 20. Prior to contact of the fuel, vaporization element 28 is controllably heated by electric resistance to a predetermined surface temperature which is sufficient to cause virtually instantaneous vaporization of the fuel but is not high enough to cause ignition thereof. Air flow 26 passing through openings 24 in standoff 20 sweeps the vaporized fuel out of vapor generator 10 and forms a gaseous fuel/air mixture 27 within manifold 18. Fuel injector 12 is pulsed repeatedly over a predetermined period of time, as needed, to provide enhanced starting capability of the engine 100 (FIG. 2) when cold.

Preferably, element 28 is energized before engine starting is desired, for example, by turning of a vehicle ignition key or by opening of the driver's door, to initiate a heating delay of a few seconds prior to onset of engine cranking, fuel injection, and spark ignition.

Referring to FIG. 2, an exemplary air intake manifold 18 comprises a central plenum 40 and a plurality of runners 42 extending from and supplied with air from plenum 40. In the present example, manifold 18 is configured for a V-6 engine 100. Runners 42 supply air and fuel to each of the six combustion cylinders (not shown). In each runner 42 is a port fuel injector 44. An air inlet 46 to plenum 40 includes a throttle valve 48, as is known in the prior art. Immediately downstream of throttle valve 48, fuel vaporizer 10 is mounted in manifold 18 as shown in detail in FIG. 1. Of course, it should be recognized that alternatively fuel vaporizer 10 may be disposed in its entirety within manifold 18 as may be desired. It should be further recognized that fuel injectors 44 alternatively may be positioned outside runners 42 for direct injection of fuel into their respective combustion chambers in known fashion.

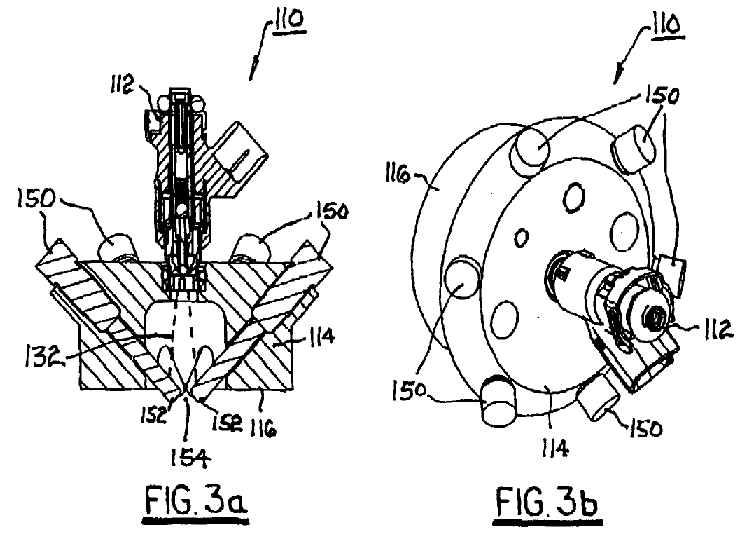

Referring now to FIGS. 3a and 3b, a second embodiment 110 of a fuel vapor generator in accordance with the invention comprises an atomizing fuel injector assembly 112 similar to injector assembly 12. Fuel injector assembly 112 is sealingly mated to a generator body 114 having a base portion 116, for mounting to the wall of intake manifold 18 (FIG. 2). A plurality of glow plugs 150, for example six glow plugs hexagonally arranged and similar in construction and operation to known 240-watt diesel engine glow plugs, are convergently mounted in generator body 114 such that the glow plug inner tips 152 define an intensely heated region 154 within intake manifold 18. Fuel sprayed from fuel injector assembly 112 through generator body 114 is vaporized by contact with inner tips 152 and/or by exposure to heated region 154. As in first embodiment 10, vaporized fuel is continuously swept from region 154 by intake air entering manifold 18.

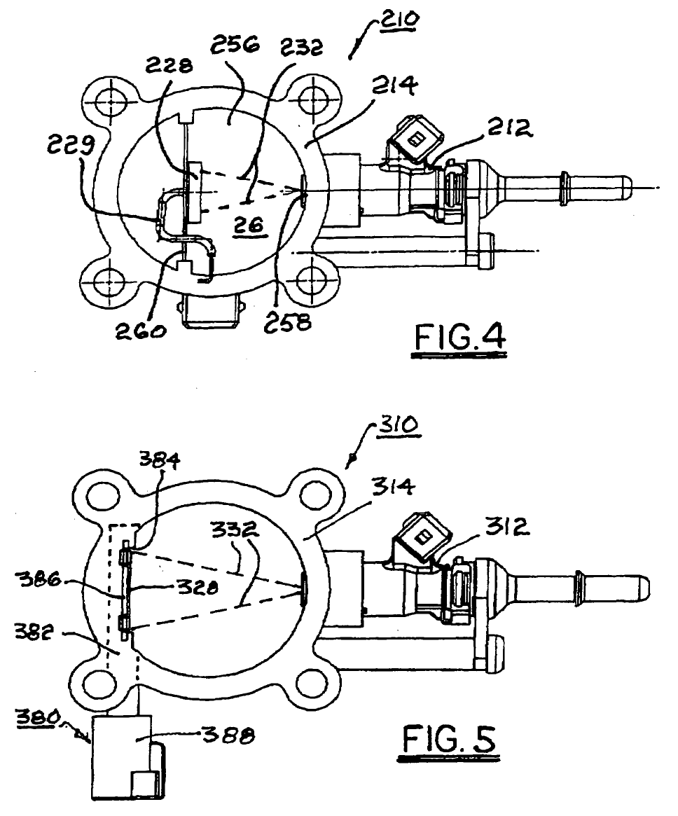

Referring to FIG. 4, a third embodiment 210 of a fuel vapor generator in accordance with the invention comprises an atomizing fuel injector assembly 212 similar to injector assemblies 12,112. Fuel injector assembly 212 is sealingly mated to a generator body 214 formed to fit transversely of manifold air inlet 46 (FIG. 2) between throttle valve 48 and plenum 40. Embodiment 210 thus becomes part of air inlet 46, intake air 26 passing through throat region 256. A radial bore 258 in the wall of generator body 214 permits fuel to be injected from injector assembly 212 into throat region 256. A heater element 228, energized via a cable 229, is positioned and mounted in throat region 256 by a support 260 extending across throat region 256. Heater element 228, which may be formed as described for elements 28,128 or otherwise as described below, is thus a spaced-apart target for atomized fuel spray 232.

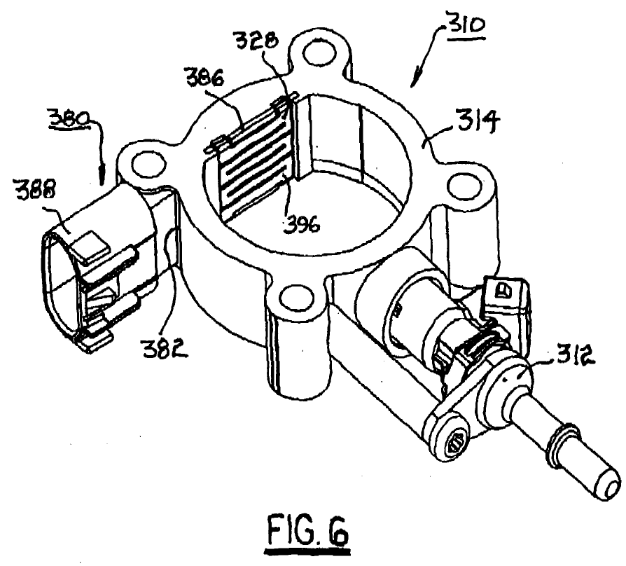

Referring to FIGS. 5 and 6, a fourth embodiment 310 of a fuel vapor generator in accordance with the invention comprises an atomizing fuel injector assembly 312 similar to injector assemblies 12,112,212. Fuel injector assembly 312 is sealingly mated to a generator body 314 similar to generator body 214 formed to fit transversely of manifold air inlet 46 (FIG. 2) between throttle valve 48 and plenum 40.

A heater subassembly 380 is disposed in a cavity 382 formed in generator body 314 and having a window 384 exposing a heating element 328 to fuel spray 332 from injector assembly 312. Heater subassembly 380 may include an insulative backer 386 supportive of heating element 328 and an electrical connector 388 for connecting subassembly 380 to a control circuit (not shown).

Referring to FIG. 6, heating element 328 may be of any desired shape and material to form an electrically heated surface for evaporation of fuel. In one aspect of the invention, heating element 328 is formed from a sheet metal blank resulting in a continuous, sinuous shape 396 of conductive metal. In theory almost any metal can be used as long as the characteristics of the material are accounted for in the design. Steels and particularly stainless steels are a good choice for heating element 328.

It should be noted that energizing a sheet metal heating element such as element 328 without spraying fuel on it can cause it to melt. Thus, a safety device in the form of a thermistor, PTC fuse, or other temperature sensing device (not shown) is preferably attached to the element to detect its temperature, a signal from which can be used to interrupt current to the heater to protect it either directly or through a control relay or transistor in known fashion.

As described above, fuel vapor generator 10,110,210,310 is especially useful in enhancing the cold starting capabilities of an internal combustion engine by providing a gaseous air/fuel mixture 27 to each of the runners 42 instead of the pure air supplied in prior art fuel injected engines. Fuels which can be difficult to start at low temperatures may include alcohols such as ethanol and methanol, alkanes such as gasoline, and combinations thereof. Engine injectors 44 may be operated normally upon starting, or their operation may be delayed and the engine run solely on mixture 27 for some period of time during warm-up, as further described below.

The desired amount of vapor supplied to the engine can vary with the engine state. There are a number of engine parameters associated with starting and running an engine, such as RPM, Manifold Air Pressure, coolant temperature etc. The engine's control system uses this information to optimize the operation of the engine based upon the conditions, and controls hardware such as the throttle position, spark timing, and injector timing.

The amount of desired vapor generated can vary in a similar manner. Ethanol fuel will burn only in vapor form. Fuel injectors form vapor by spraying fuel under pressure through small holes at the injector tip. At lower temperatures, the amount of liquid fuel converted into vapor from the injectors is diminished. This missing portion of vapor normally supplied by the injectors must be compensated by the fuel vapor generator. Since the vapor supplied from the engine injectors is variable, so must be the amount of desired vapor from the generator.

As the engine is started, the cylinder temperatures, Manifold Air Pressure, and RPM all change, as does the required total amount of fuel. Thus the desired amount of generated vapor will change as the starting sequence progresses, as will the required amount of heater power. Thus the injector and heater power in the fuel vaporizer must be modulated (profiled) as operation progresses. This can be as simple as time based (open loop control), or closed loop from the engine's crank sensor (RPM & Position), coolant sensor, etc. If control of the fuel vaporizer is conducted within the engine's ECM, this information is readily available at no additional overall cost and can be used to optimize the operation. If control is conducted from a separate stand-alone unit, then an open-loop time-based or temperature control system may be more suitable due to cost.

Under certain conditions, the fuel vaporizer may be required to supply the entire amount of fuel to start the engine. For example, at temperatures below about −5° C. the vapor conversion efficiency of the engine's fuel injectors is very poor (less than 1% of the fuel is converted into vapor form). This can result in wetting of the spark plugs with liquid fuel (known in the art as “flooding”), which can prevent the engine from starting. To prevent flooding and to permit starting under these conditions, an improved strategy may be employed wherein the engine's port or direct injectors are disabled and the entire amount of fuel is supplied from the fuel vaporizer for some period of time after starting. This of course necessitates sizing a larger and more powerful vaporizing unit to supply the additional quantity of vapor.

The vaporizer can also supplement the engine's fuel injectors after the engine starts and warms sufficiently to run well on only the injectors. After starting, the engine and fuel are still relatively cold, and the engine's injectors are still supplying only a fraction of the available fuel energy in vapor form, which limits the available engine torque. Auxiliary fuel supplied from the vaporizer after the engine starts can increase the amount of available engine power, thus improving vehicle drivability and customer satisfaction.

Various approaches may be used to control a manifold fuel vapor generator in accordance with the invention, for example:
1. Watch-dog timer: This is a timer that measures the amount of time that the heater is on. When the timer reaches a predetermined set limit, the operation of the vaporizer is interrupted so that the temperature of the heater stays below a predetermined maximum, for example, either the flash point of the fuel or the point at which the heater may be damaged. Control may not be limited to time alone. The amount of applied power may be changed over time either by PWM control or by use of a PTC material in the heating element. An integral may be implemented that estimates the element temperature from the duration and level of applied power.
2. Thermal protection device: This is a hardware device attached to the heater element that will interrupt the operation of device should a set maximum temperature be reached. This “Thermal Fuse” may comprise a thermistor, a PTC or other thermal circuit breaker, or an actual piece of metal used as a fuse that melts open at the desired temperature. Preferably, any circuit interrupter is automatically resettable when the temperature overage is no longer present.
3. Preheat time: A settable time period during which heating element power is applied before the fuel is injected onto the heating element. This allows the heating element to come up to operational temperature so that fuel begins to vaporize immediately upon contact with the heating element.
4. Adiustable fuel Profile: The amount of fuel sprayed upon the heater can be adjusted based upon elapsed time, engine position, engine RPM, and/or various other feedback signals. Feedback can be from, but is not limited to, the engine crank sensor (yields engine position/RPM), coolant temperature, or other temperature sensor. For example, when the control system detects that the engine is starting to turn, it is known in the prior art how to determine air-flow (speed-density), either by estimation or by a reading from a Mass Air Flow sensor such as is used in many current engines. Using this estimate and any of various other factors that influence the required fuel, such as temperature and Manifold Air Pressure, the fuel flow can be adjusted accordingly.
5. Constant power/variable flow: In this approach, the heater element is slightly over-sized than needed to meet its performance requirements. The power supplied to the heater is not pulse-width modulated to limit heater temperature. Constant power is supplied to the heater and the fuel sprayed on its surface (for example, volume, pattern, or rate) is regulated to control the temperature of the heater. For purposes of regulating the fuel spray, the actual temperature of the heater may be measured by a temperature sensor mounted on or near the heater, or may be estimated by a “State Estimator” as described below.

Another form of vaporizer control within the scope of the invention is a “State Estimator”. Such a control strategy can utilize open-loop techniques to operate the vaporizer or may utilize any of the forms of feedback mentioned above. This form of control uses techniques similar to items #1 & #4 above.

In brief, a State Estimator mathematically models the system and adjusts the controllable features based upon an estimated present state.

The state of the system can be modeled from measurements taken (calibration) when the “Master” (standard) hardware is built. This is similar to the process used to calibrate fuel injectors. An automobile control system doesn't measure the amount of fuel supplied to the engine; fuel is metered via the injector's calibration. Fuel injection is is thus an open loop process. The control system can supply the desired amount of fuel from this calibration data. It outputs a pulse width modulation (PWM) signal that corresponds to the calibration data for the desired fuel flow.

Of course, the injector used in an engine isn't the same injector used for the actual calibration measurement wherein the calibration of a representative “Master” injector is measured. However, because the injector used in the vehicle is the same design as the “Master” with minor variations due to the tolerances of the parts, the actual flows are very similar. The same strategy applies to the injector used in the vaporizer.

The operating slope (change in temperature@ power/time) of the heating element can be easily established through laboratory measurements, as can the ethanol conversion efficiency which is the actual amount of ethanol converted into vapor versus the amount of ethanol that should theoretically be converted into vapor at the measured amount of power into the system. The conversion efficiency is used to estimate the required amount of power to control the heating element for a given fuel flow.

Too much or too little power supplied to the heating element can present problems. Too much power leads to too high a heater temperature which can lower the conversion efficiency by forming a vapor barrier between the fuel and the heating element, thereby decreasing the amount of heat transferred into the incoming fuel. Further increases in temperature can ignite the fuel or burn out the heating element. Too little power results in too little fuel being vaporized to start the engine.

Various factors such as the amount of fuel flow may affect the power conversion efficiency. Actual power conversion efficiency may be estimated by interpolating efficiency vs. fuel flow data as measured on the “Master” vaporizer.

Another control approach can utilize many of the concepts in the State Estimator control system to control the vaporizer's fuel injector, but instead of utilizing conversion efficiencies etc. to estimate the required power, the power to the heating element can be controlled by closed loop temperature control. As more fuel is sprayed onto the element, more heat is removed thus cooling the element and requiring more power to be supplied to the heating element. Control may be accomplished in more than one way.

A first way is to utilize a self limiting Positive Temperature Coefficient (PTC) heating element. As noted above, this is a heating element material that has a sufficiently high thermal resistance coefficient that the temperature is self regulated. As temperature increases so does resistance, decreasing the current and power flowing through the heating element. A limiting temperature is set somewhere above the fuel's boiling temperature but below the auto-ignition temperature. As the element cools from addition fuel, more power is automatically supplied to the element without any intervention from the vaporizer controller.

A second way is to utilize a thermistor or a PTC type circuit breaker attached to the heating element. As the trigger temperature of the control device is reached, the current is interrupted and heating ceases. Then as the heater element cools, the control device starts conducting again, thus repeating the cycle. Once again, no intervention from the vaporizer controller is required.

A third way is to attach one of the various temperature sensing devices directly to the heating element. This sensor is connected to a control system, and the measured temperature is used via P.I.D. control or some other available means to control the power to the heater.

It should be understood that numerous changes may be made within the spirit and scope of the inventive concepts described, including but not limited to other configurations, materials, and locations of vaporization elements. Accordingly, it is intended that the invention not be limited to the described embodiments, but will have full scope defined by the language of the following claims.

What is claimed is:

1. A fuel vapor generator for vaporizing fuel in an air supply stream of an internal combustion engine, comprising:
a) a fuel source for injecting fuel into air supply stream; and
b) an electrically-powered fuel vaporizer off-spaced from said fuel source and disposed in said air supply stream for receiving and vaporizing fuel injected by said fuel source.

2. A vapor generator in accordance with claim 1 wherein said fuel vaporizer includes an electric resistance heating element.

3. A vapor generator in accordance with claim 2 wherein said electric resistance heating element is formed from a material having a positive thermal coefficient of resistance.

4. A vapor generator in accordance with claim 1 wherein said fuel vaporizer includes at least one glowplug.

5. A vapor generator in accordance with claim 2 wherein said electric resistance heating element includes a sheet metal plate.

6. A vaporizer in accordance with claim 5 wherein said metal plate is formed in a sinuous shape.

7. A vapor generator in accordance with claim 1 wherein said fuel source includes a solenoid-actuated fuel injector.

8. A vapor generator in accordance with claim 1 further including a perforated hollow cylinder disposed between said fuel source and said fuel vaporizer.

9. A vapor generator in accordance with claim 1 further comprising a generator body formed into a shape to cause said fuel vaporizer to be off-spaced from said fuel source.

10. A vapor generator in accordance with claim 9 wherein said generator body shape is formed to permit inclusion of said generator body into an inlet portion of an intake manifold of said internal combustion engine.

11. An internal combustion engine comprising an air intake manifold and a fuel vapor generator mounted on said manifold, wherein said fuel vapor generator includes a fuel source for injecting fuel into said manifold, and a fuel vaporizer disposed within said manifold for vaporizing fuel injected by said fuel source.

12. An internal combustion engine in accordance with claim 11 wherein said air intake manifold further includes an air inlet throttle valve, and wherein said vapor generator is disposed downstream of said air inlet throttle valve.

13. An internal combustion engine in accordance with claim 11 wherein said engine is selected from the group consisting of spark-ignited and combustion-ignited.

14. A method for enhancing the starting and running of an internal combustion engine having an air intake manifold and a plurality of combustion cylinders, comprising the steps of:
a) providing an electrically heated fuel vapor generator within said air intake manifold;
b) injecting liquid engine fuel onto said fuel vapor generator to vaporize an amount of said fuel;
c) forming a gaseous mixture of said vaporized fuel and air within said manifold; and
d) passing said gaseous mixture into said combustion cylinders.

15. A method in accordance with claim 14 wherein said internal combustion engine further includes a plurality of engine fuel injectors distributed among said plurality of combustion cylinders, and wherein the injecting action of said engine fuel injectors is inhibited during starting of said engine.

16. A method in accordance with claim 14 wherein said internal combustion engine requires a predetermined fuel flow for starting, and wherein a first portion of said predetermined fuel flow is delivered to said cylinders by said fuel vapor generator and a second portion of said predetermined fuel flow is delivered to said cylinders by said engine fuel injectors.

17. A method in accordance with claim 14 wherein said internal combustion engine requires a predetermined fuel flow for starting, and wherein all of said predetermined fuel flow is delivered to said cylinders by said fuel vapor generator and none of said predetermined fuel flow is delivered to said cylinders by said engine fuel injectors.

18. A method in accordance with claim 17 further comprising the steps of:
a) providing a timer that measures the elapsed time that said electrically heated fuel vapor generator is energized;
b) predetermining a limit of time for continuous elapsed operating time of said fuel vapor generator; and
c) interrupted the energizing of said fuel vapor generator when said predetermined limit of time is reached so that the temperature of said fuel vapor generator stays below a predetermined maximum temperature.

19. A method in accordance with claim 17 further comprising the steps of:
a) providing a thermally-responsive link in an electrical circuit in said fuel vapor generator, said link being attached to a heating element in said fuel vapor generator;
b) predetermining a maximum temperature limit for operation of said heating element; and
c) when said predetermined maximum temperature limit is reached, responding to interrupt the energizing of said heating element in a manner selected from the group consisting of opening said thermally-responsive link and sending a signal to a controller for said fuel vapor generator to de-energize said heating element.

20. A method in accordance with claim 17 further comprising the additional step before engine startup of providing a predetermined time delay between energizing of said electrically heated fuel vapor generator and cranking of said engine.

21. A method in accordance with claim 17 further comprising the steps of:
a) determining an instantaneous value for a correct flow of fuel into said fuel vapor generator; and
b) controlling flow of fuel through said fuel vapor generator to said correct flow value, based upon parameters including but not limited to elapsed vapor generation time, engine speed (RPM), and engine temperature.

22. A method in accordance with claim 17 further comprising the steps of:
a) measuring an actual operation temperature of said heating element; and
b) responding to said measured actual operation temperature by regulating the liquid engine fuel being injected on the fuel vapor generator to attain a desired operation temperature of the heating element.

23. A method in accordance with claim 21 wherein said controlling step is carried out based upon additional parameters selected from the group consisting of air flow through said engine, intake air temperature, fuel temperature, and manifold air pressure.
